(19) United States
(12) Patent Application Publication
(10) Pub. No.: US 2008/0013179 A1
(43) Pub. Date: Jan. 17, 2008

(54) Multi-layer film and image display device

(75) Inventors: Takashi Kobayashi, Fujinomiya-shi (JP); Akira Hatakeyama, Fujinomiya-shi (JP); Katsuyoshi Suzuki, Fujinomiya-shi (JP); Tatsuya Nomura, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/826,441

(22) Filed: Jul. 16, 2007

(30) Foreign Application Priority Data
Jul. 14, 2006 (JP) 2006-193589

(51) Int. Cl. G02B 1/10

(52) U.S. Cl. 359/587

(57) ABSTRACT

A first layer containing a binder and fine particles having any one of tin oxide, indium oxide, zirconium oxide, and titanium oxide as a main component is formed at least on one surface of a base material formed of polyester in this order from a side of the base material. A second layer is disposed so as to be in contact with the first layer. Thereby, a multi-layer film is formed. When a refractive index of the base material is η1, that of the first layer is η2, and that of the second layer is η3, a formula denoted by η1<η2<η3 is satisfied. The multi-layer film has strong adhesive strength between layers, and exhibits excellent optical properties by efficiently preventing occurrence of rainbow unevenness due to interference of light on the interface. Further, the multi-layer film is used as a component of an image display device, thus ensuring excellent image quality.

### FIELD OF THE INVENTION

The present invention relates to a multi-layer film, and an image display device such as a liquid crystal display (LCD), a plasma display (PDP), an organic electroluminescence display (organic EL display), surface-conduction electron-emitter display (SED), a cathode ray tube display (CRT display), or the like using the multi-layer film as its component.

### BACKGROUND OF THE INVENTION

In accordance with an increase in demand for an image display device such as a LCD, a PDP, an organic EL display, a SED, and a CRT display, demand for an optical film as its main component has been rapidly increasing for the purpose of obtaining high-quality image thereof. The optical film is a film provided with various optical functions for achieving prevention of reflection of external light, enlargement of viewing angle, correction of optical unevenness, and the like.

The optical film is generally a multi-layer film having a multi-layer structure composed of a base material of the optical film, and an upper layer deposited thereon. The base material is typically a transparent film including a polymer as a main component. Among the base materials, the demand for a base material formed of polyester has been increasing because of its features such as being excellent in transparency, dimensional stability, chemical resistance, low hygroscopicity, and the like. The upper layer includes a polymer as its main component and additives for applying various optical functions such as prevention of reflection of light on the multi-layer film. As the upper layer there are an antireflection layer, a prism layer, a light scattering layer, and the like, for example. By arbitrarily deciding combination between the base material and the upper layer, it is possible to readily form various optical films such as a prism film, an antireflection film, and a light scattering film for use in the LCD, and further an infrared ray (IR) absorption film, an electromagnetic wave shielding film, a toning film, an antireflection film, an antiglare film, a hard coat film, and the like for use in the PDP, for example.

However, in a case where adhesive strength between the base material and the upper layer is low, the upper layer may be peeled from the base material, thus causing light leakage and making it impossible to prevent light from reflecting. Therefore, the adhesive strength is important in the multi-layer film, however, it is difficult to enhance the adhesive strength to a predetermined level since the adhesive strength tends to be easily affected by material composition of the base material and the upper layer, irregularities on the contact surface, formation condition of each layer, and the like. In view of the above, for example, in Japanese Patent Laid-Open Publication No. 2001-294826, there is disclosed a stacked film in which the base material contains polyester, and an adhesion assist layer including polyester is formed thereon, thus enhancing the adhesive strength.

Moreover, since the multi-layer film is composed of a plurality of materials, whose refractive indices are different from each other, such as the base material, the adhesion assist layer, and the upper layer, light is easily reflected on the interfaces. Further, when light is reflected on the interfaces, the reflected light interfere with each other to cause a phenomenon in which the light seems rainbow (rainbow unevenness). Accordingly, displaying quality in using the multi-layer film drastically deteriorates. At present, a refractive index of a typical base material composed of polyester is approximately 1.65 that is relatively high. Accordingly, there is proposed a constitution in which the refractive index of a layer next to the base material is increased so as to decrease the difference in refractive indices between the base material and the layer next to the base material. For example, in Japanese Patent Laid-Open Publication No. 2004-054161, there is disclosed a stacked film including an upper layer (coating layer) containing fine particles as a predetermined metal oxide so as to have higher refractive index. In Japanese Patent Laid-Open Publication No. 2005-097571, there is disclosed a stacked film including a layer, in which coating liquid containing a water-soluble composition and water is applied to a base material composed of polyester, and a layer stretched at least in one direction as an upper layer. Furthermore, in Japanese Patent Laid-Open Publication No. 2000-111706, there is disclosed a stacked film including a base material having higher refractive index, an adhesion assist layer having refractive index adjusted such that difference in refractive index between the base material and the adhesion assist layer is decreased, and an upper layer, by focusing on refractive index of polymer and arbitrarily making a decision.

The rainbow unevenness also occurs by thickness irregularity of each layer. In particular, in a case where thickness irregularity exists on the upper layer, the reflected light becomes more intense at a certain thickness, and rainbow unevenness is more apparent on the multi-layer film, thus causing a problem. In view of the above, in Japanese Patent Laid-Open Publication No. 2003-177209, for example, there is disclosed a method in which a film is produced while adjusting a refractive index of the adhesion assist layer and the film thickness so as to prevent occurrence of rainbow unevenness. Further, in Japanese Patent Laid-Open Publication No. 2005-178173, there is disclosed a stacked film including a layer having higher refractive index by adding inorganic fine particles having titanium dioxide as its main component to at least one of surfaces of a transparent base material.

In any case describe above, fine particles, a chelate compound, or the like is added for the purpose of improving refractive indices of the base material and each of the layers and adjusting optical properties. However, in this case, the fine particles, the chelate compound, or the like precipitates between the base material and the adhesion assist layer, and between the adhesion assist layer and the upper layer, and then the adhesive strength therebetween decreases, thus causing a problem. Furthermore, when a large amount of fine particles are added for the purpose of increasing the refractive index, strength of each of the layers decreases, thus consequently causing deterioration of the film as a whole. Additionally, in Japanese Patent Laid-Open Publication No. 2003-177209, there is disclosed a method in which polymer having a desired refractive index is arbitrarily selected to be used and thereby a refractive index of an adhesion assist layer is adjusted. However, such a polymer is expensive mostly, and therefore manufacturing cost increases, thus causing a problem.

### SUMMARY OF THE INVENTION

In view of the above, a first object of the present invention is to provide a multi-layer film having a multi-layer structure, exhibiting excellent adhesive strength between the materials and preventing occurrence of rainbow unevenness, and further having excellent optical properties such as antireflection function. Additionally, a second object of the present invention is to provide an image display device exhibiting excellent displaying quality by using the multi-layer film as an optical film.

A multi-layer film of the present invention includes: a base material formed of polyester; a first layer disposed on at least one of surfaces of the base material, the first layer containing a binder having a refractive index of 1.60 or more and fine particles having any one of tin oxide, indium oxide, zirconium oxide, and titanium oxide as its main component; and a second layer disposed on the first layer. The multi-layer film is characterized in that when a refractive index of the base material is η1, a refractive index of the first layer is η2, and a refractive index of the second layer is η3, a formula denoted by η1<η2<η3 is satisfied.

The η1, η2, and η3 preferably satisfy a formula denoted by −0.03≦η2−(η1×η3)^{1/2}≦0.03. Further, the binder includes preferably polyester.

The first layer preferably contains a compound having a plurality of carbodiimide structures in its molecule.

When a wavelength λ of visible light is in a range of 500 nm to 600 nm, a thickness d1 (nm) of the first layer and the η2 preferably satisfy a formula denoted by −30≦d1−λ/(4×η2)≦30. Note that preferably the polyester is polyethylene terephthalate, and both η2 and η3 are 2.0 or less.

Moreover, the second layer is preferably a hard coat layer. An antireflection layer is preferably disposed on the hard coat layer. A refractive index of the antireflection layer is preferably 1.50 or less.

An image display device of the present invention is characterized by including a multi-layer film as defined in any one of the above.

According to the present invention, it is possible to provide a multi-layer film having a multi-layer structure in which a first layer and a second layer are stacked on a base material formed of polyester in this order from a side of the base material. The multi-layer film has excellent adhesive strength between materials and prevents occurrence of rainbow unevenness. As a second layer, an optically functional layer such as a hard coat layer and an antireflection layer, and physically functional layer excellent in rub resistance are formed. Thereby, it is possible to obtain an optical film having excellent optical properties such as a hard coat film and an antireflection film. Additionally, by using the optical film thus obtained as its component, it is possible to obtain an image display device exhibiting excellent displaying quality.

### BRIEF DESCRIPTION OF THE DRAWINGS

One with ordinary skill in the art would easily understand the above-described objects and advantages of the present invention when the following detailed description is read with reference to the drawings attached hereto:

FIG. 1 is a schematic diagram illustrating a multi-layer film according to an embodiment of the present invention; and

FIG. 2 is a schematic diagram illustrating a multi-layer film that is an optical film serving as an antireflection film according to an embodiment of the present invention.

### DESCRIPTION OF THE PREFERRED EMBODIMENTS

Hereinafter, the present invention is explained in detail by referring to Embodiments. However, the present invention is not limited thereto.

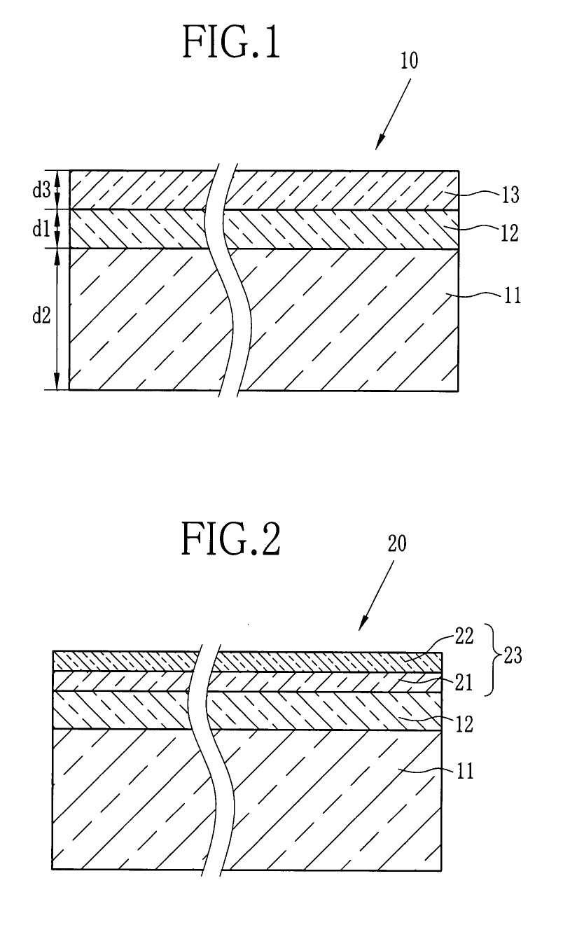

First of all, the present invention is explained according to a first embodiment. As shown in FIG. 1, a multi-layer film 10 includes a base material 11 formed of polyester in a film form, a first layer 12 and a second layer 13 laminated on the base material 11 in this order from a side of the base material 11. The first layer 12 may be formed on not only one surface of the base material 11 but also both surfaces thereof. For example, when the first layer 12 is additionally formed on another surface of the base material 11 and a near infrared ray absorption (NIRA) coat layer is formed on the additional first layer 12, it is possible to form the NIRA coat layer on another surface of the base material 11 with strong adhesive force. Such a multi-layer film having the NIRA coat layer can be preferably used as an antireflection film for a plasma display panel (PDP). Note that the antireflection film is omitted in FIG. 1 for the purpose of avoiding complicity of the figure.

The first layer 12 and the second layer 13 are composed of at least one layer formed of a polymer, respectively. The number and the kind of layers for constituting the first and second layers 12 and 13 are not especially limited. When each of the first and second layers 12 and 13 has a multi-layer structure, it is not necessary that the compositions of the layers for constituting each of the first and second layers 12 and 13 are identical with each other. In any case, the composition may be arbitrarily decided based on the various applications or the like. Both the first and the second layers 12 and 13 shown in FIG. 1 have a single-layer structure composed of one layer.

When a refractive index of the base material 11 is η1, a refractive index of the first layer 12 is η2, and a refractive index of the second layer 13 is η3, the following formula is satisfied: η1<η2<η3. Accordingly, reflection of light can be prevented on an interface, and it is possible to suppress occurrence of rainbow unevenness due to the interference of light. According to the present invention, the refractive indices of adjacent layers are adjusted so as to satisfy the above condition, and thereby it is possible to obtain the multi-layer film 10 having the multi-layer structure and capable of suppressing occurrence of rainbow unevenness. Further, it is possible to adjust the refractive index of each layer by adding fine particles to each layer while regulating the kind and the containing amount of the particles or by arbitrarily selecting the refractive index of polymer to be used as a binder. The method of measuring refractive indices may be any well-known method and not especially limited. Note that the refractive indices of the layers of the present invention are values caused by visible light having a wavelength in a range of 550 nm to 600 nm.

Moreover, it is preferable that η1, η2, and η3 satisfy the following formula: −0.03≦η2−(η1×η3)^{1/2}≦0.03, more preferably −0.02≦η2−(η1×η3)^{1/2}≦0.02, and most preferably −0.01≦η2−(η1×η3)^{1/2}≦0.01. Accordingly, it is possible to further suppress occurrence of rainbow unevenness on the multi-layer film 10.

Moreover, when λ as the wavelength of visible light is in a range of 550 nm to 600 nm, it is preferable that d1 (nm) as the thickness of the first layer 12 and η2 satisfy the following formula: −30≦d1−λ/(4×η2)≦30, more preferably −20≦d1−λ/(4×η2)≦20, and most preferably −10≦d1−λ/(4×η2)≦10. The multi-layer film 10 having the first layer 12 with the thickness and refractive index adjusted respectively as described above prevents reflection of light on the interface, thus suppressing the occurrence of the rainbow unevenness as interference of light.

The formula (1) shows relation among η1, η2, and η3. The formula (2) shows relation between the thickness d1 and the refractive index η2 of the first layer 12. For example, it is considered that reflection of light on an interface between the base material 11 and the first layer 12 can be prevented when the following formulae are satisfied: η2=(η1)^{1/2} and η2×d1=λ/4 in a case where the second layer is air in general. Each of the formulae is described in a general book of optical field such as “Handbook of Optical Technology” (p. 449, edited by Kubota Hiroshi et al., published by Asakura Publishing Co., Ltd, 1979). Accordingly, when the values constituting the formulae are adjusted so as to satisfy the above formulae (1) and (2), the degree of reflection on the interface becomes zero in theory. Note that it is sufficient to change the kinds of materials or add the fine particles in order to make the refractive index of the layer approach its theoretical value. However, in the above state, it is difficult to make the degree of reflection approach its theoretical value since there occur absorption of light, scattering of light, or the like. Further, when the multi-layer film 10 having a multi-layer structure is produced as shown in FIG. 1, the factors of the multi-layer film 10 become complex, and therefore it becomes further difficult to produce the multi-layer film 10. However, it is confirmed that it is possible in actual to prevent the reflection of light on the interface and occurrence of rainbow unevenness based on the above formulae even when the relation among η1, η2, and η3 and relation between the thickness d1 and the refractive index η2 of the first layer 12 slightly deviate from the formulae (1) and (2), respectively. Therefore, according to the present invention, the formulae (1) and (2) applicable to the multi-layer film having a multi-layer structure are defined by taking the allowable range of the formulae (1) and (2) into consideration, and a more appropriate value is defined.

[Base Material]

Polyester used for formation of the base material 11 is not especially limited, and well-known ones can be used. Concretely, there are polyethylene terephthalate, polyethylene naphthalate, polybutylene terephthalate, polybutylene naphthalate, and the like, for example. Among them, in view of manufacturing cost, mechanical strength, or the like, polyethylene terephthalate is preferably used. When the base material 11 is formed of polyethylene terephthalate, each of η2 and η3 is preferably 2.0 or less. Here, when each of the refractive indices exceeds 2.0, there arises necessity of adding a large amount of fine particles to the first layer 12 and the second layer 13, thus resulting in deterioration of the intensity of each layer. Note that η1 is more preferably in a range of 1.62 to 1.68.

The base material 11 of the present invention is preferably biaxially stretched. The biaxially stretching means that each of the width direction and the longitudinal direction of the base material 11 is considered as one axis, and the base material 11 is stretched in both directions. The biaxially molecular orientation of the base material 11 biaxially stretched as described above is sufficiently controlled, and therefore the base material 11 has excellent mechanical strength. Although the draw ratio thereof is not especially limited, the draw ratio thereof in one direction is preferably 1.5 to 7 times, and more preferably 2 to 5 times. In particular, molecular orientation of the base material obtained by being biaxially stretched with the draw ratio in one direction of 2 to 5 times is controlled more efficiently, and therefore the base material has very excellent mechanical strength to be suitable as the base material 11. However, when the draw ratio of the base material 11 is less than 1.5 times, it is not possible to obtain efficient mechanical strength. On the contrary, the draw ratio thereof exceeds 7 times, it becomes difficult to obtain uniform thickness, thus causing a problem.

A thickness d2 (μm) of the base material 11 is preferably in a range of 30 μm to 400 μm, and more preferably in a range of 35 μm to 350 μm. The thickness of the base material 11 can be adjusted readily by controlling the draw ratio thereof. The base material 11 as described above has transparency and various optical properties, and is light and easy to be handle. However, the base material 11 having the width d2 of less than 30 μm may be too thin and difficult to handle. On the contrary, the base material 11 having the width d2 of more than 400 μm may be too thick and unsuitable, since the base material 11 having the width d2 of more than 400 μm has difficulty in downsizing and lighting of an image display device and causes an increase in manufacturing cost.

Although a thickness d3 (μm) of the second layer 13 is not especially limited, it is preferably in a range of 1 μm to 10 μm, and more preferably in a range of 2 μm to 5 μm. Thereby, the second layer 13 has desired optical functions and mechanical functions such as rub resistance, and further can secure high adhesive strength between the first layer 12 and the second layer 13. However, when the d3 is less than 1 μm, the extent of rub resistance is low, since it may be difficult to achieve sufficient optical functions and physical functions. On the contrary, when the d3 exceeds 10 μm, it may be difficult to secure high adhesive strength between the first layer 12 and the second layer 13. Note that when the second layer 13 has a multi-layer structure, total thickness of the second layer 13 is considered as d3.

[First Layer]

The first layer 12 includes a binder having the refractive index of 1.60 or more and fine particles. The fine particles contain at least one of tin oxide, indium oxide, zirconium oxide, and titanium oxide as its main component. Here, the main component means a component whose percentage is 50% or more in the fine particles. The first layer 12 is formed on the base material 11. The second layer 13 formed on the first layer 12 functions as adhesion assist layer. Note that a binder contained in the first layer 12 and having the refractive index of 1.60 or more is referred to as a first binder.

The first binder is polyvinylidene chloride, polyester, or the like, for example. Among them, the first binder is preferably polyester having high refractive index. When the first layer 12 described above is formed on the base material 11 including polyester, it is possible to secure high adhesive strength between the base material 11 and the first layer 12.

Polyester is a collective term of a polymer having ester bond in its main chain. Generally, polyester is obtained by a reaction between polycarboxylic acid and polyol. Polycarboxylic acid is, for example, fumaric acid, itaconic acid, adipic acid, sebacic acid, terephthalic acid, isophthalic acid, naphthalene dicarboxylic acid or the like. Among them, terephthalic acid and naphthalene dicarboxylic acid are preferably used. Especially, naphthalene dicarboxylic acid as an acid component is preferable for polyester having high refractive index. The content of naphthalene dicarboxylic acid relative to the total amount of the acid components in the polyester is preferably in a range of 30 mol % to 99 mol %, more preferably in a range of 40 mol % to 95 mol %, and most preferably in a range of 50 mol % to 90 mol %. The content described above exceeds 99 mol %, it may be difficult to achieve water solubility and water dispersibility. On the contrary, the content described above of less than 30 mol % may not be suitable, because the degree of increase in refractive index is small. One copolymerized with sulfoisophthalic acid sodium is preferably used as a binder having water solubility and water dispersibility.

As polyol, there are, for example, ethylene glycol, propylene glycol, 1,4-butanediol, 1,6-hexanediol, glycerin, hexanetriol, neopentyl glycol, polyethylene glycol, polypropylene glycol, polytetramethylene glycol, ethylene oxide adduct of bisphenol A (NC-1910, produced by Nippon Nyukazai Co., Ltd. or the like), polyester polyol, and the like.

As described above, according to the present invention, since the first layer 12 includes the first binder having high refractive index of at least 1.60, and fine particles having any one of tin oxide, indium oxide, zirconium oxide, and titanium oxide as its main component, it is possible to obtain a layer having high refractive index without increasing an amount of the fine particles. Thereby, it is possible to form the first layer 12 having a desired refractive index while suppressing deterioration of layer strength caused by the increased content of fine particles and keeping high layer strength. Additionally, since the additive amount of the fine particles is not required to be a lot, it is also possible to improve the problem of flaw of the layer. Note that the content of the first binder can be obtained on an experimental basis by use of a desired refractive index of the first layer 12, a binder to be used other than the first binder, and the kinds of fine particles. The content of the first binder relative to the total amount of the binders in the first layer 12 is preferably in a range of 20 mass % to 100 mass %, more preferably in a range of 30 mass % to 100 mass %, and most preferably in a range of 40 mass % to 100 mass %.

As described above, when the fine particles are used for the purpose of adjusting the refractive index or the like, there is a possibility of deterioration of light transmittance of the first layer 12 due to large foreign substances formed by aggregation of the fine particles. In this case, it is possible to prevent the aggregation of the fine particles by deciding the diameter and the kind of the fine particles preferably. In order to efficiently prevent the aggregation of the fine particles, the average diameter of the fine particles is preferably in a range of 5 nm to 200 nm, more preferably in a range of 10 nm to 100 nm, and most preferably in a range of 15 nm to 70 nm. When the fine particles having average diameter of more than 200 nm are used, there is possibility in which the transparency of the first layer 12 and the light transmittance decrease. On the contrary, when the fine particles having average diameter of less than 5 nm are used, since the manufacturing cost thereof is high, the manufacturing cost of the first layer 12 increases, or the fine particles easily aggregate and become large foreign substances to decrease the transparency of the first layer 12, thus causing undesirable result. Note that, according to the present invention, the average diameter of the fine particles is an average diameter of arbitrarily selected 50 fine particles when the diameter of fine particle is considered as a diameter of a circle having the same dimension as that of fine particle captured by a scanning electron microscope.

The fine particles used for the first layer 12 are preferably tin oxide, zirconium oxide, or titanium oxide among the fine particles listed above in view of its availability and relatively low cost.

Tin oxide (IV) having a composition of SnO₂ is preferably used. Further, the tin oxide is preferably doped by antimony or the like as a doping agent. Since the tin oxide doped as described above has conductivity, it is possible to prevent decrease in surface resistivity of the multi-layer film and prevent impurities such as dust from adhering to the surface of the multi-layer film. As the tin oxide doped by antimony, there are, for example, FS-10D, SN-88F, SN-38F, SN-100F, TDL-S, and TDL-1 (all of them are produced by ISHIHARA SANGYO KAISHA, LTD.), and the like. They are preferably applicable to the present invention. Note that tin oxide using phosphorus as a doping agent can be also preferably used.

Zirconium oxide (IV) having a composition of ZrO₂ is preferably used. For example, there are NZS-20A and NZS-30A (both of them are produced by NISSAN CHEMICAL INDUSTRIES, LTD), and the like. Titanium oxide (IV) having a composition of TiO₂ is preferably used. There are rutile-type (high-temperature tetragonal) titanium dioxide, anatase-type (low-temperature tetragonal) titanium dioxide, and the like, in accordance with the quartz structure, however the titanium dioxide is not especially limited thereto. Additionally, titanium dioxide with the surface subjected to surface treatment also can be used. As titanium dioxide to be used preferably, there are IT-S, IT-O, and IT-W (all of them are produced by Idemitsu Kosan Co., Ltd.), and the like.

As described above, the first layer 12 may include a plurality of binders. Polyester used as the first binder and other kinds of binders are described, for example, in “Polyester Resin HandBook” (written by Eiichiro Takiyama, published by Nikkan Kogyo Shinbun, Ltd. in 1988).

Other kinds of binders are, for example, (a) acrylate, (b) polyurethane, (c) rubber-based resin, and (d) polyester. As for (a) acrylate resin, there are polymers including acrylic acid, methacrylic acid, and derivatives thereof as its components. As such acrylate, there is a polymer in which acrylic acid, methacrylic acid, methyl methacrylate, ethyl acrylate, butyl acrylate, 2-ethylhexyl acrylate, acrylamide, acrylonitrile, hydroxylacrylate (hydroxyacrylate), or the like as a main component is copolymerized with and monomer capable of being copolymerized with the main component described above. Note that the monomer is in a state copolymerized with the main component. The monomer is, for example, styrene, divinylbenzene, or the like.

As for (b) polyurethane as a collective term of polymer having urethane bond in its main chain, in general, polyisocyanate and polyol react to obtain the polyurethane resin. Polyisocyanate is TDI, MDI, NDI, TODI, HDI, IPDI, or the like. Polyol is ethylene glycol, propylene glycol, glycerin, hexanetriol, or the like. Additionally, according to the present invention, as isocyanate, there can be used a polymer in which polyisocyanate and polyol react to obtain the polyurethane polymer and the polyurethane polymer is subjected to chain extension process to increase molecular weight thereof. Polyisocyanate, polyol, and chain extension process are described, for example, in “Handbook of polyurethane resins” (edited by Keiji IWATA, and published by Nikkan Kogyo Shimmbun Ltd., in 1987).

As for (c) rubber-based resin, the rubber-based resin is diene type synthetic rubber among synthetic rubber. The diene type synthetic rubber is, for example, polybutadiene, styrene-butadiene copolymer, styrene-butadiene-acrylonitrile copolymer, styrene-butadiene-divinylbenzene copolymer, butadiene-acrylonitrile copolymer, polychloroprene, or the like. Note that the rubber-based resin is described, for example, in “Handbook of Synthetic Rubber” (edited by Shu Kanbara et al., published by Asakura Publishing Co., Ltd, 1967). Further, one described in the description about the first binder may be used as (d) polyester.

The polymer to be used as the first binder especially preferably has carboxyl group in the molecules. Note that, in using the first binder, there may be used a mixture in which a desired polymer is dissolved in an organic solvent, or water dispersion in which water is dispersed. The first binder also may be water-soluble polymer. It is preferable to use water dispersion or water-soluble polymer as the first binder since it is possible to perform water-based application while suppressing environment load. The water dispersion and water-soluble polymer may be commercialized products, and are not especially limited.

The water dispersion and water-soluble polymer used as the first binder is polyvinylidene chloride latex (Saran latex produced by Asahi Kasei Corporation), water-soluble polyester polymer (product name: Z-687, produced by GOO CHEMICAL CO., LTD), or the like.

The water dispersion or water-soluble polymer used together with the first binder is, for example, polyurethane water dispersion such as Superflex 830, 460, 870, 420, and 420NS (product name, produced by Dai-ichi Kogyo Seiyaku Co., Ltd.) and Vondic 1370N and 1320NS, Hydran AP-40F (product name, produced by Dainippon Ink & Chemicals, Inc.), acrylic water dispersion such as Jurymer ET325, ET410, and SEK301 (product name, produced by Nihonjunyaku Co., Ltd.), Bon Coat AN117 and AN226 (product name, produced by Dainippon Ink & Chemicals, Inc.), styrene-butadiene rubber-based water dispersion such as Lack star DS616 and DS807 (product name, produced by Dainippon Ink & Chemicals, Inc.), Nippol LX110, LX206, LX426, and LX433 (product name, produced by ZEON CORPORATION), acrylonitrile-butadiene rubber-based water dispersion such as Nippol LX513, LX1551, LX550, and LX1571 (product name, produced by ZEON CORPORATION), polyester water dispersion such as Finetex ES 650 and ES2200 (product name, produced by Dainippon Ink & Chemicals, Inc.), Vylonal MD1400 and MD1480 (product name, produced by TOYOBO., LTD), polyester water-soluble polymer such as Plus coat Z-221, Z-561, Z-730, and RZ-142 (product name, produced by GOO CHEMICAL CO., LTD), or the like.

Although the first binder 12 to be used for the first layer 12 and molecular weight of the polymer to be used together with the first binder 12 are not especially limited, for the purpose of achieving excellent handling property and forming a layer with preferable flat surfaces, in general, it is preferable that weight-average molecular weight is in a range of 3000 to 1000000. When weight-average molecular weight of the polymer is less than 3000, the strength of the first layer 12 may be insufficient. On the contrary, when weight-average molecular weight of the polymer exceeds 1000000, flowability is poor and application becomes difficult, and therefore the planarity of surface of the first layer 12 may decrease, thus causing undesirable result.

It is preferable that the first layer 12 includes a compound containing a plurality of carbodiimide structures in its molecule. In a case where the first layer 12 includes such a compound, when the first layer 12 contains the fine particles, it is possible to prevent the fine particles from being peeled therefrom. The carbodiimide-based compound is not especially limited as long as it has a plurality of carbodiimide groups. Further, the number of the carbodiimide groups is not also limited. In general, polycarbodiimide is synthesized by contractile response of organic diisocyanate. The organic group of organic diisocyanate to be used in the synthesis is not especially limited, and may be one of aromatic group and aliphatic group, or a mixture group thereof. In view of reactivity, the aliphatic group is especially preferable. The material for the synthesis is organic isocyanate, organic diisocyanate, organic triisocyanate, or the like.

The organic isocyanate may be aromatic isocyanate, aliphatic isocyanate, or a mixture thereof. Concretely, there may be used 4,4′-diphenylmethane diisocyanate, 4,4-diphenyl dimethylmethane diisocyanate, 1,4′-phenylene diisocyanate, 2,4-tolylenesocyanate, 2,6-tolyleneisocyanate, hexamethylene diisocyanate, cyclohexane diisocyanate, xylylene diisocyanate, 2,2,4-trimethylhexamethylene diisocyanate, 4,4′-dicyclohexylmethane diisocyanate, 1,3-phenylene diisocyanate, or the like. Further, organic monoisocyanate may be isophorone isocyanate, phenyl isocyanate, cyclohexyl isocyanate, butyl isocyanate, naphthyl isocyanate, or the like. Furthermore, as carbodiimide-based compound applicable to the present invention, Carbodilite V-02-L2 (product name, produced by Nisshinbo Industries, Inc.) or the like as a commercialized product is available.

The amount of the carbodiimide-based compound of the present invention to be added to the binder is preferably in a range of 1 mass % to 200 mass %, more preferably in a range of 5 mass % to 100 mass %. In a case where the additional amount of the carbodiimide-based compound is less than 1 mass %, when the first layer 12 contains the fine particles, it may not be possible to prevent sufficiently the fine particles from being peeled therefrom. On the contrary, in a case where the additional amount of the carbodiimide-based compound exceeds 200 mass %, the planarity of surface of the first layer 12 may be decreased. Accordingly, both cases are not preferable.

The first layer 12 may include the fine particles functioning as a matting agent for improving slidability or the like. The matting agent may be organic or inorganic fine particles. For example, as the matting agent, there are polymer fine particles such as polystyrene, polymethylmethacrylate, silicone, and benzoguanamine, and inorganic fine particles such as silica, calcium carbonate, magnesium oxide, and magnesium carbonate. Among them, polystyrene, polymethylmethacrylate, and silica are preferably used in view of improving slidability and achieve low cost.

In order to provide preferable slidability, the average diameter of the fine particles of the matting agent is preferably in a range of 0.01 μm to 12 μm, more preferably in a range of 0.03 μm to 9 μm. When the average diameter of the fine particles of the matting agent is less than 0.01 μm, it may be difficult to achieve preferable slidability. On the contrary, when the average diameter of the fine particles of the matting agent is exceeds 12 μm, the displaying quality of the image display device may be deteriorate. Accordingly, the average diameter of the particles of the matting agent of more than 12 μm is not suitable. Moreover, the additional amount of the matting agent is variable in accordance with the average diameter of the fine particles. For the purpose of achieving excellent improving efficiency of slidability and preventing deterioration of displaying quality of the image display device, the additional amount of the matting agent is preferably in a range of 0.1 mg/m² to 30 mg/m², more preferably in a range of 0.5 mg/m² to 20 mg/m². Note that the average diameter of the fine particles of the matting agent according to the present invention is measured by the same method as that used for measuring the average diameter of the fine particles described above.

The first layer 12 may include various additives such as a surfactant. The surfactant is, for example, well-known anionic system, nonionic system, or cationic system. The surfactant applicable to the present invention is described, for example, in “Handbook of Surfactants” (edited by Ichiro Nishi et al., published by Sangyo-Tosho, 1960). When the surfactant is used, additional amount thereof is preferably in a range of 0.1 mg/m² to 30 mg/m², more preferably in a range of 0.2 mg/m² to 10 mg/m². When the additional amount of the surfactant is less than 0.1 mg/m², it may be difficult to obtain effect of the surfactant, and therefore crawling/beading may be generated on the first layer 12. On the contrary, when the additional amount of the surfactant exceeds 30 mg/m², the surface of the first layer 12 may be deteriorated, thus causing undesirable result.

An antistatic agent may be used in the first layer 12 to prevent static charge. The kind of the antistatic agent is not especially limited, and as the antistatic agent, for example, there are electron conductive polymers such as polyaniline and polypyrrole, ion conductive polymers having carboxyl group and sulfonate group in its molecular chain, conductive fine particles, and the like. The conductive fine particles may be common fine particles having tin oxide, zirconium oxide, titanium oxide, and indium oxide as its main component. For example, the conductive fine particles of tin oxide described in Japanese Patent Laid-Open Publication No. 61-020033 may be preferably used in view of its conductivity and transparency. When the antistatic agent is used, the additional amount thereof is preferably adjusted such that the surface resistivity of the first layer 12 measured at the temperature of 25° C. and under the RH atmosphere of 30% is in a range of 1×10⁵Ω to 1×10¹³Ω. However, when the surface resistivity of the first layer 12 is less than 1×10⁵Ω, it means that a large amount of antistatic agent is used, and therefore the transparency of the first layer 12 may be deteriorated. On the contrary, when the surface resistivity of the first layer 12 exceeds 1×10¹³Ω, it means that the effect of preventing static charge is insufficient, and therefore there is possibility in that impurities such as dust adhere to the surface of the first layer 12, thus resulting in a problem.

Lubricant is preferably used in the first layer 12 in order to improve its slidability. The lubricant is preferably aliphatic wax, and the preferable additional amount thereof is in a range of 0.1 mg/m² to 30 mg/m², more preferably in a range of 0.5 mg/m² to 10 mg/m². However, when the additional amount of lubricant is less than 0.1 mg/m², it may be difficult to achieve sufficient slidability. On the contrary, when the additional amount of lubricant exceeds 30 mg/m², there is possibility in that the adhesive strength between the first layer 12 and the second layer 13 decreases, thus resulting in a problem. Note that the aliphatic wax applicable to the present invention is described in detail in Japanese Patent Laid-Open Publication No. 2004-054161.

The method of forming the first layer 12 is explained. In this embodiment, the first layer 12 is formed by a so-called coating method. In the coating method, coating liquid in which the first binder, fine particles, additives, and the solvent are preliminarily mixed together is applied to the surface of the base material 11 to form a coating layer, and then the coating layer is dried. As described above, since the coating liquid obtained by diluting the first binder and the like by the solvent has fluidity and therefore is easy to handle, it is possible to form readily a coating layer with uniform thickness. The solvent described above, that is, the solvent for coating may be water, toluene, methyl alcohol, isopropyl alcohol, methyl ethyl ketone, and the mixture thereof. Note that the solubility of the first binder, additives, and the like relative to the solvent in the coating liquid is not especially limited. Accordingly, the coating liquid may be either dissolved or dispersed one. Further, the solvent for coating may be water. In this case, water functions as solvent for coating. When water is used as solvent for coating as described above, it is possible to reduce the manufacturing cost and facilitate the manufacturing process.

When the coating layer is dried, the content of the remaining solvent in the coating layer after being dried becomes preferably 5 mass % or less, more preferably 2 mass % or less, and most preferably 1 mass % or less. As the content of the remaining solvent in the coating layer decreases, polymerization rate of the polymer can be increased. Therefore, it is possible to obtain a layer in which unevenness in the optical characteristic distribution decreases in its plane. The drying condition of the coating layer may be arbitrarily decided in accordance with the thermal strength, feeding speed, the span of the drying process of the base material 11 and the first layer 12, and the like, and is not especially limited.

Although it is preferable that the coating liquid is applied to the base material 11 biaxially stretched as described above, it is also possible to stretch the base material 11 biaxially by forming the first layer 12 on the base material 11 stretched uniaxially and then stretching the base material 11 uniaxially in a direction different from one in the first uniaxially stretching. Here, one axis is considered as one of the width direction and the longitudinal direction of the base material 11. In biaxially stretching the base material 11, the order of the width direction and the longitudinal direction is not limited.

The method of forming the first layer 12 is not especially limited as long as a layer having a desired thickness can be obtained. Accordingly, the coating method is not also limited, and may be a well-known method used in forming a thin film. For example, there are a dipping method, a spinner method, a spray method, a roll coater method, a gravure method, a wire bar method, a slot extrusion method (single-layer and multi-layer), a slide coater method, and the like. The above methods can be used in forming the layer of the present invention, that is, the layer constituting the first an second layers 12 and 13.

[Second Layer]

The second layer 13 is disposed such that the distance between the second layer 13 and the base material 11 is longer than the distance between the first layer 12 and the base material 11, and functions as an outermost layer of the multi-layer film 10. In general, the second layer includes a layer having rub resistance, functional layers each having an optical function, and the like. It is preferable to form a hard coat layer as the second layer 13, because it is possible to obtain an optical film functioning as the hard coat film. The functional layer is not limited to this embodiment, and may be formed by arbitrarily selecting in accordance with a desired property. For example, when an antireflection layer is formed, an optical film functioning as an antireflection film can be obtained. Note that the hard coat film and the antireflection film are described later.

The present invention is explained according to a second embodiment. A multi-layer film 20 is the same as the multi-layer film 10 shown in FIG. 1 except that a second layer 23 is different from the second layer 13. Therefore, the reference numerals of the base material and the first layer are common in the first embodiment and the second embodiment in the description. The explanation of the thickness, optical properties such as refractive index, and materials of the film will be omitted.

As shown in FIG. 2, the multi-layer film 20 includes the base material 11 having the refractive index of η1, the first layer 12 having the refractive index of η2, and the second layer 23 having the refractive index of η3. The second layer 23 is an optical layer formed of two layers, one being a hard coat layer 21, and the other being an antireflection layer 22. The hard coat layer 21 corresponds to the second layer 13 shown in FIG. 1. The hard coat layer 21 is preferably formed of energy setting polymer or thermosetting resin. In particular, the energy setting polymer is preferably used. The energy setting polymer is hardened by being irradiated with active energy ray, and therefore suffers less damage in comparison with the thermosetting polymer using heat as energy in being hardened. Accordingly, the energy setting polymer has an advantage in that a layer having high transparency can be formed. Note that the energy setting polymer is described in detail later.

The energy setting polymer to be used in forming the hard coat layer 21 is explained. The energy setting polymer is preferably a setting polymer having at least two acrylic groups in the same molecular. For example, there are polyol polyacrylates such as ethylene glycol diacrylate, 1,6-hexanediol diacrylate, bisphenol-A diacrylate, trimethylolpropane triacrylate, ditrimethylolpropane tetraacrylate, pentaerythritol triacrylate, pentaerythritol tetraacrylate, dipentaerythritol pentaacrylate, and dipentaerythritol hexaacrylate; polyfunctional urethane acrylate obtained by a reaction between polyisocyanate curable polymer and hydroxyl-containing acrylate such as hydroxyethyl acrylate; and polyfunctional epoxy acrylate obtained by a reaction between polyepoxy curable polymer and hydroxyl-containing acrylate (methacrylate) such as hydroxyethyl acrylate. Additionally, polymer having ethylenic unsaturated group in its side chain also can be used.

When the energy setting polymer is used, it is preferable that ionizing radiation such as radiation as active energy, gamma (γ) rays, alpha (α) rays, electron rays, ultraviolet rays, or the like are irradiated to the coating layer. Thereby, since the polymer can be hardened efficiently and effectively, it becomes possible to form a coating layer having sufficient hardness, that is, the hard coat layer 21. Note that, when the hard coat layer 21 is formed, it is preferable that, after the coating liquid for forming the hard coat layer 21 is applied to the first layer 12 to form the coating layer, ultraviolet rays are irradiated to the coating layer. Thereby, it is possible to obtain the hard coat layer 21 having uniform thickness and no unevenness in the optical properties in a short period of time. Note that if the above coating liquid is one obtained by preliminarily diluting the desired energy setting resin, polymerization initiator, or the like by the solvent, it is possible to form a coating layer having uniform thickness readily, thus causing a preferable result.

In order to achieve an anti-reflection function, it is preferable that the refractive index of the antireflection layer 22 is lower than that of the hard coat layer 21. The refractive index of the hard coat layer 21 is preferably set to a value in a range of 1.68 to 2.00 by adding the inorganic fine particles to the binder for use in forming the hard coat layer 21. In general, the refractive index of the inorganic fine particles is as high as in a range of 1.6 to 2.7. Therefore, the refractive index of the layer to be formed can be adjusted readily within the range described above.

Conventionally, the adjustment has been performed in forming a layer having a low refractive index by using a material having a low refractive index such as fluorinated material and silicone material as the binder. For example, when the refractive index of the hard coat layer 21 was set to 1.60, the optimum refractive index of the antireflection layer 22 was approximately 1.26. However, it is insufficient to select and use the binder as described above in order to make the refractive index of the antireflection layer 22 less than 1.35. In view of the above, in a case where a hard coat layer having high refractive index is formed as described above, when a hard coat layer having the refractive index of 1.85 is formed, the antireflection layer having the optimum refractive index of approximately 1.36 can be formed readily. Accordingly, the setting of the refractive index of the antireflection layer 23 is facilitated, and further it is possible to form the multi-layer film 20 functioning as an antireflection film having low extent of reflection. Note that the inorganic fine particles described above may be the same as that used in the first layer 12. Thereby, the explanation of the fine particles are applied correspondingly, and thus the explanation thereof is omitted here.

The antireflection layer 22 may have a multi-layer structure including a layer having a low refractive index and a layer having a high refractive index. The surface hardness of the antireflection layer 22 described above is relatively high, and the antireflection layer 22 has a function of preventing reflection of light on the surface of the hard coat layer 21. Therefore, the antireflection layer 22 has excellent rub resistance and optical properties. Note that, according to the present invention, the layer having a low refractive index has a refractive index in a range of 1.35 to 1.50, and the layer having a high refractive index has a refractive index in a range of 1.68 to 2.00.

Although the multi-layer film 20 obtained as described above has a multi-layer structure, the multi-layer film 20 has high adhesive strength between the layers and prevents the interference of light on the interfaces, thus decreasing occurrence of rainbow unevenness. The multi-layer film 20 having excellent optical properties as described above can be used as the antireflection film having excellent displaying quality in the various image display devices.

According to the present invention, one kind of polymerization initiator may be used, or two or more kind of polymerization initiators may be used. Further, although the additional amount of the polymerization initiator is not also especially limited, the additional amount thereof is preferably in a range of 0.1 mass % to 15 mass % of the total amount of curable polymer having ethylenic unsaturated group and curable polymer having ring-opening polymerizable group in the curable polymer composition, more preferably in a range of 1 mass % to 10 mass %.

As the example of composition capable of forming the hard coat layer having high refractive index, there is one in which polyfunctional acrylic acid ester-based monomer used as a polymer component contains the inorganic fine particles such as alumina and titanium oxide. The example is disclosed in Japanese Patent No. 1815116. In addition to this, photopolymerizable compound composition containing the fine particles having alumina is described in Japanese Patent No. 1416240. These descriptions are also applicable to the present invention. However, the hard coat layer 21 of the present invention is not limited to the above examples.

Moreover, the hard coat layer 21 having high refractive index also can be formed by using a polymer having high refractive index. The polymer having high refractive index may be a polymer having a cyclic group, a polymer having halogen atom other than fluorine, a polymer having both cyclic group and halogen atom other than fluorine, or the like for example. Note that the cyclic group includes an aromatic group, a heterocyclic group, an alicyclic group, and the like. In forming the antireflection layer 22, commercially available coating material may be used as the antireflection film. In a case where a layer having low refractive index is formed, the coating material may be a commercially available coating material having low refractive index such as TT1148, TU2111, and TU2153 (all of them are produced by JSR Corporation) or the like. In a case where a layer having high refractive index is formed, the coating material may be a commercially available coating material having high refractive material such as Z7410C, Z7410D, and Z7410E (all of them are produced by JSR Corporation) or the like.

The multi-layer film of the present invention can be used as an optical film for use in a liquid crystal display, a plasma display, an organic EL display, a surface-conduction electron-emitter display (SED), and a CRT display. These image display devices are described in detail, for example, in “Display Advanced Technology” (edited by Chizuka Tani, published by Kyoritsu Publication Inc, 1998). “EL, PDP, and LCD Displays (issued by TORAY RESEARCH CENTER, INC., 2001), “Color liquid crystal display” edited by Shunsuke Kobayashi, published by Sangyo Tosho Publishing Co., Ltd., 2000), and the like.

According to the present invention, various functional layer such as the hard coat layer or the antireflection layer are arbitrarily selected to be used as the second layer, and therefore it is possible to obtain a multi-layer film having excellent optical properties. The multi-layer film having a function as the optical film can be preferably used as the antireflection film and the hard coat film for use in liquid crystal display; the optical film such as the antireflection film, an IR absorption film, an electromagnetic wave shielding film, and a toned film for use in PDP; and a film filter obtained by integrating them together. Note that these films are described in “Electric Journal”, p. 74, Aug. 8, 2002, for example, in addition to the above documents.

Hereinafter, the present invention is explained in detail by referring to Examples and Comparative Examples. Note that Examples and Comparative Examples hereinbelow are considered as an example of the present invention, and the present invention is not limited thereto. Accordingly, the kinds of materials, the rate of the materials, treatments, and the like may be arbitrarily changed within the spirit of the present invention. Further, hereinafter the manufacturing method and the conditions thereof are explained in detail in Example 1, and the same ones as those of Example 1 will be omitted in other Examples and Comparative Examples.

### EXAMPLE 1

In this example, in accordance with the following procedure, the multi-layer film 10 shown in FIG. 1 was formed. Note that the second layer 13 has a single-layer structure composed of the hard coat layer 21 solely.

[Base Material]

Polyethylene terephthalate (hereinafter referred to as PET) having inherent viscosity of 0.66 was synthesized by polycondensation reaction. The catalyst used in the reaction was antimony trioxide. The PET was dried until the water content thereof became less than 50 ppm, and thereafter melted in an extruder having a heater set at the temperature of 280 to 300° C. Next, the melted PET was discharged onto a chill roll to which electrostatic charge was applied from a die section, thus obtaining an amorphous film. Subsequently, the amorphous film was stretched 3.3 times in the longitudinal direction of the film, and further stretched 3.8 times in the width direction thereof, thus completing the biaxially stretching and producing the base material 11 having the thickness of 100 μm. Note that the refractive index η1 of the base material 11 thus obtained was 1.65.

[First Layer]

While the base material 11 was transferred at the feeding speed of 70 m/min, the surface thereof was subjected to corona discharge treatment under the condition of 730J/m². Thereafter, a coating liquid A was applied to both surfaces of the base material 11 by a bar coating method to form the coating layer. Then, the coating layer was dried at the temperature of 180° C. for one minute to form the first layer 12. Note that the application amount of the coating liquid A was 4.4 ml/m² on each of the surfaces.

[Coating Liquid A]

Each of the materials whose application amount of solid content is as follows respectively is mixed together to prepare the coating liquid A.

| | |
|---|---|
| First polyester | 16.1 (mg/m²) |
| Second polyester | 24.2 (mg/m²) |
| Carbodiimide-based compound | 8.1 (mg/m²) |
| Carnauba wax | 2.4 (mg/m²) |
| Surfactant A | 0.4 (mg/m²) |
| Surfactant B | 2.4 (mg/m²) |
| First fine particle dispersion liquid | 1.0 (mg/m²) |
| Second fine particle dispersion liquid | 189 (mg/m²) |

As for the above materials, the first polyester is FINE TEX ES650 (solid content of 29%, refractive index of 1.55, and glass transition temperature of 30° C.) produced by Dainippon Ink & Chemicals, Inc., and the second polyester is a product Z687 (solid content of 25%, refractive index of 1.63, and glass transition temperature of 110° C.) produced by GOO CHEMICAL CO., LTD. Further, the carbodiimide-based compound is Carbodiright V-02-L2 (water solution with solid content of 10% and carbodiimide equivalence of 385) produced by Nisshinbo Industries, Inc. The carnauba wax is Cellosol 524 that is water solution with solid content of 3% and produced by CHUKYO YUSHI CO., LTD. Furthermore, the surfactant A is Rapisol B-90 that is water solution with solid content of 1%, anionic, and produced by NOF CORPORATION. The surfactant B is Naloacty HN-100 that is water solution with solid content of 5%, nonionic, and produced by Sanyo Chemical Industries, Ltd. The first fine particle dispersion liquid is dispersion liquid in which silica fine particle are dispersed in water. The silica fine particles are OX-50 produced by NIPPON AEROSIL CO., LTD. In the first fine particle dispersion liquid, OX-50 with the content of 10% is dispersed. The second fine particle dispersion liquid contains antimony doped tin oxide with the content of 17%. The second fine particle dispersion liquid is SN-38F (having an average diameter of fine particles of 30 nm) produced by ISHIHARA SANGYO KAISHA, LTD.

The thickness of the first layer 12 after being dried was measured with use of a transmission electron microscope (JEM2010, produced by JEOL Ltd.) at the magnification of 200000 times. As a result, the thickness d1 of the first layer 12 was 81 nm. Further, the refractive index of the first layer 12 measured by a method described below was 1.70. Note that in measuring the thickness, the base material 11 provided with the first layer 12 was taken as a sample “a”.

[Measurement of Refractive Index of First Layer]

The refractive index of a sample “b” provided with the coating layer formed of the coating liquid A at the wavelength of 660 nm and 850 nm was measured respectively with use of a refractive index measuring device (SPA-4000, produced by Sairon Technology, Inc.) by a prism coupler method. Next, based on the measurement value of the refractive index at each wavelength and the following Celmaire formula, the refractive index at the wavelength of 550 nm was calculated as the refractive index η1 of the first layer. Note that Celmaire formula is denoted by: η²−1=Aλ²/(λ²−B). Here, λ is a measured wavelength (nm), η is a refractive index at the measured wavelength, and A and B are constants. After the constants A and B were calculated by assigning the measured wavelength and the refractive index to the above formula, the wavelength of 550 nm was assigned thereto, thus obtaining the refractive index at the wavelength of 550 nm. The sample “b” was produced by applying the coating liquid A to a commercially available silicon wafer such that the thickness thereof after being dried became a value in a range of 3 to 4 μm to form the coating layer, and then drying the resultant at the temperature of 105° C. for 10 minutes.

[Hard Coat Layer]

Ultra violet (UV) curable polymer (product name: 7410E, refractive index of 1.75, and produced by JSR Corporation) was applied to one surface of the first layer 12 thus obtained such that the thickness thereof became approximately 9 μm to form the coating layer. Thereafter, the coating layer was dried at the temperature of 70° C. for 1 minute. Next, ultra violet rays were irradiated to the dried coating layer with use of a high pressure mercury lamp to harden the resin, thus forming the hard coat layer with the thickness of 4 μm. Note that the irradiation amount of the ultra violet rays to the coating layer was set to 1000 mJ/cm². Furthermore, the refractive index η3 of the hard coat layer was measured by the same method in measuring the refractive index of the first layer. The measurement value was 1.75.

### EXAMPLE 2

A multi-layer film was formed in the same manner as example 1 except that zirconium oxide dispersion liquid was instead of the second fine particle dispersion liquid in the coating liquid A. The zirconium oxide dispersion liquid was zirconium oxide sol (product name: HZ-307W6, water solution with solid content of 20%, and produced by Nissan Chemical Industries, Ltd). The application amount of solid content was 189 (mg/m²). Furthermore, the thickness and refractive index of the first layer 12 corresponding to Example 2 were measured in the same manner as Example 1. The result was: η2=1.70 and d1=88 nm.

### EXAMPLE 3

A multi-layer film was formed in the same manner as example 1 except that indium oxide dispersion liquid was used instead of the second fine particle dispersion liquid in the coating liquid A. The indium oxide dispersion liquid was EP ITO DL-1 (water solution with solid content of 20%, and produced by JEMCO INC.). The application amount of solid content was 170 (mg/m²). Furthermore, the thickness and refractive index of the first layer 12 corresponding to Example 3 were measured in the same manner as Example 1. The result was: η2=1.70 and d1=78 nm.

### EXAMPLE 4

A multi-layer film was formed in the same manner as example 1 except that a coating liquid B was used instead of the liquid coating liquid A. The coating liquid B was a compound liquid, in which the second fine particle dispersion liquid in the coating liquid A was shifted to a third fine particle dispersion liquid described later, and the application amount of solid content of each material was changed. Furthermore, the thickness and refractive index of the first layer 12 corresponding to Example 4 were measured in the same manner as Example 1. The result was: η2=1.70 and d1=80 nm. Note that the respective materials were the same as those in Example 1, and therefore the description thereof will be omitted.

[Coating liquid B]

| | |
|---|---|
| First polyester | 20.0 (mg/m²) |
| Second polyester | 30.0 (mg/m²) |
| Carbodiimide-based compound | 10.0 (mg/m²) |
| Carnauba wax | 3.0 (mg/m²) |
| Surfactant A | 0.5 (mg/m²) |
| Surfactant B | 3.0 (mg/m²) |
| First fine particle dispersion liquid | 1.2 (mg/m²) |
| Third fine particle dispersion liquid | 55.0 (mg/m²) |

[Third Fine Particle Dispersion Liquid]

First of all, 50 parts by mass of titanium dioxide fine particles (product name: Idemitsu titania TI-W, produced by Idemitsu Kosan Co., Ltd.) was added to 450 parts by mass of ionized water after being stirred with use of a stirrer (product name: Robomics, produced by PRIMIX Corporation). Next, after the resultant was stirred for 10 minutes to disperse the fine particles into the ionized water, the dispersion liquid was dispersed at the output of 9.0 by an ultrasonic dispersion machine (product name: UH600S, produced by MST Corporation) for 8 minutes, thus preparing the third fine particle dispersion liquid that was water solution with solid content of 10%.

### EXAMPLE 5

A multi-layer film was formed under the same conditions as those of example 1. Although the first polyester is contained in the coating liquid A in Example 1, urethane (product name: Superflex 860 with the solid content of 40%, produced by Dai-ichi Kogyo Seiyaku Co., Ltd.) is contained in the coating liquid A in Example 5. The application amount of solid content was 16.7 (mg/m²). Furthermore, the thickness and refractive index of the first layer 12 corresponding to Example 5 were measured in the same manner as Example 1. The result was: η2=1.70 and d1=81 nm.

### COMPARATIVE EXAMPLE 1

The first layer 12 was not formed, and the second layer 13 was formed directly on the base material 11 as the PET film to form the multi-layer film.

### COMPARATIVE EXAMPLE 2

A multi-layer film was formed in the same manner as example 1 except that the coating liquid A prepared without containing the second fine particle dispersion liquid was used. Further, the thickness and refractive index of the first layer 12 corresponding to Comparative Example 2 were measured in the same manner as Example 1. The result was: η2=1.57 and d1=54 nm.

### COMPARATIVE EXAMPLE 3

The second polyester was used instead of the first polyester in the coating liquid A. Further, the first layer 12 was formed such that application amount of solid content of the second fine particle dispersion liquid became 239 (mg/m²) in order to set the refractive index of the first layer 12 to 1.70. However, it was not possible to form a film having uniform thickness.

The multi-layer films formed in Examples and Comparative Examples were evaluated as to the following 4 items such as the adhesion, the optical properties, and the like. Evaluation 1 shows adhesive extent between the base material and the first layer. Evaluation 2 shows adhesive strength of the second layer. Evaluation 3 shows a state of application surface of the multi-layer film. Evaluation 4 shows whether rainbow unevenness occurred or not on the multi-layer film. The details of the respective evaluation methods are shown hereinbelow.

[1. Adhesion Extent Between Base Material and First Layer]

First of all, in Examples and Comparative examples, the coating liquid used for forming the first layer was applied to the surface of the base material 11, and a sample “c” thus obtained was soaked in distilled water at the temperature of 60° C. for 16 hours. Next, the sample “c” after being soaked was taken from the distilled water, and a drop of water adhered to the surface of the sample “c” was wiped lightly by a piece of paper (product name: kimwipe S-200, produced by NIPPON PAPER CRECIA CO., LTD.). Thereafter immediately the surface of the sample “c” was scratched by a diamond stylus of 0.1R with use of a scratch resistance strength tester (product name: HEIDEN-18, produced by Shinto Scientific Co., Ltd.). The scratched area was observed by a microscope of 100 times power, and then the condition of the peeled first layer 12 was checked with eyes and judged based on a standard mentioned below. Thereby, the adhesion extent between the base material and the first layer, that is, the adhesion therebetween was evaluated by five stages. Further, a load applied to the diamond stylus was set to 200 g. Note that in the below evaluation, if the product is evaluated as rank A or B, the level thereof is sufficient.

### Rank A: No peeling.

### Rank B: The peeled area is less than 30% of the whole area scratched by the diamond stylus.

### Rank C: The peeled area is not less than 30% and less than 70% of the whole area scratched by the diamond stylus.

### Rank D: The peeled area is not less than 70% and less than 100% of the whole area scratched by the diamond stylus.

### Rank E: In addition to the area scratched by the diamond stylus, the coating layer near the scratched area is also peeled.

[2. Adhesive Strength of Second Layer]

First of all, the humidity of the multi-layer film 10 thus obtained was adjusted at the temperature of 25° C. under the atmosphere of 60% RH for 24 hours to obtain a sample “d”. Next, 25 lattices were formed on the surface of the sample “d” to be evaluated by making 6 scratches in the longitudinal and width directions thereof respectively with use of a single-edged razor blade. Thereafter, cellophane tape (number of 405, width of 24 mm, and produced by Nichiban Co., Ltd.) was adhered thereto. The cellophane tape was completely adhered to the surface of the scratched sample “d” by rubbing the cellophane tape by an eraser, and then the cellophane tape was peeled off in a direction of 90 degrees. Thereby, the number of lattices peeled off was obtained to evaluate the adhesive strength of the second layer, that is, adhesion thereof by five stages. In the below evaluation, if the product is evaluated as rank A or B, the level thereof is sufficient. Note that, the width of each scratch was 3 mm in the longitudinal and width directions.

### Rank A: No peeling.

### Rank B: The number of lattices peeled off was less than 1.

### Rank C: The number of lattices peeled off was not less than 1 and less than 3.

### Rank D: The number of lattices peeled off was not less than 3 to less than 20.

### Rank E: The number of lattices peeled off was 20 or more.

[3. State of Application Surface of Multi-Layer Film]

First of all, the coating liquid used for forming the first layer was applied to the surface of the base material 11 to obtain a sample “e”. Next, the sample “e” was put on a disk onto which black doeskin cloth was stuck, and fluorescent diffused light having passed through a creamy white acrylic sheet was irradiated to the coating layer. Then, light reflected thereon was observed with eyes to judge the application unevenness based a standard mentioned below, thus evaluating the application surface by three stages. Note that, in the below evaluation, if the product is evaluated as rank A or B, the level thereof is sufficient.

### Rank A: Application unevenness was not observed with eyes on both the sample “e” subjected to blackening treatment and the sample “e” not subjected to blackening treatment.

### Rank B: Although application unevenness was observed with eyes on the sample “e” subjected to blackening treatment, application unevenness was not observed on the sample “e” not subjected to blackening treatment.

### Rank C: Application unevenness was observed with eyes on both the sample “e” subjected to blackening treatment and the sample “e” not subjected to blackening treatment.

Note that on Evaluation 3, in judging with eyes, a predetermined area of the surface of the sample “e” was subjected to blackening treatment in order to prevent reflection from the rear surface thereof, and the transmittance of light at the wave length of 500 nm was adjusted so as to be 1% or less. In the blackening treatment described above, magic marker (product name: art line, refilling ink for oil based ink, KR-20 black, produced by Shachihata Inc.) was applied to a surface of the sample “e” opposed to the surface to be observed. Thereafter, the surface was dried.

[4. Whether Rainbow Unevenness Occurred or not on Multi-Layer Film]

First of all, the humidity of the multi-layer film 10 thus obtained was adjusted at the temperature of 25° C. under the atmosphere of 60% RH for 24 hours to obtain a sample “f”. Next, a surface of the sample “f” not having the coating layer was rubbed with sand paper adequately, and then the black magic marker for use in Evaluation 3 was applied thereto in order to prevent reflection from the rear surface thereof. Thereafter, the sample “f” was put on a disk and illuminated with a three-wavelength fluorescent lamp (product name: National PALOOK fluorescent lamp FL20SS·EX-D/18) from above with keeping a distance of 30 cm to cause interference fringe (rainbow unevenness), and the interference fringe was observed with eyes. The interference fringe caused in the observation was considered as rainbow unevenness and evaluated based on the below standard by five stages. Note that, in the below evaluation, if the product is evaluated as rank A, B, or C, the level thereof is sufficient.

### Rank A: No rainbow unevenness was observed.

### Rank B: Almost no rainbow unevenness was observed.

### Rank C: Rainbow unevenness was slightly observed.

### Rank D: A large amount of rainbow unevenness was observed strongly.

### Rank E: A very large amount of rainbow unevenness was observed.

The results in Examples and Comparative Examples were collectively shown in Table 1. In Table 1, “Ex” denotes Example, “Com” denotes Comparative Example, “Eva” denotes Evaluation, “d1” denotes the thickness of the first layer, “η1” denotes a refractive index of the support, “η2” denotes a refractive index of the first layer, and “η3” denotes a refractive index of the second layer. Further, <1> means a state in which measurement was not performed since the first layer was not formed. <2> means a state in which the planarity of surface of the first layer decreased and evaluation was impossible.

TABLE 1

| | Ex 1 | Ex 2 | Ex 3 | Ex 4 | Ex 5 | Com 1 | Com 2 | Com 3 |
|---|---|---|---|---|---|---|---|---|
| d1 (nm) | 81 | 88 | 78 | 80 | 81 | <1> | 54 | <2> |
| η1 | 1.65 | 1.65 | 1.65 | 1.65 | 1.65 | 1.65 | 1.65 | 1.65 |
| η2 | 1.70 | 1.70 | 1.70 | 1.70 | 1.70 | <1> | 1.57 | <2> |
| η3 | 1.75 | 1.75 | 1.75 | 1.75 | 1.75 | 1.75 | 1.75 | <2> |
| η2 − √(η1 × η3) | 0.00 | 0.00 | 0.00 | 0.00 | 0.00 | −1.7 | −0.13 | <2> |
| d1 − {550/(4 × η2)} | 0.12 | 7.12 | −2.89 | −0.88 | 0.12 | <1> | −33.6 | <2> |
| Eva 1 | A | A | A | A | A | <1> | A | <2> |
| Eva 2 | A | A | A | A | A | E | A | <2> |
| Eva 3 | A | A | A | A | A | <1> | A | <2> |
| Eva 4 | A | A | A | A | A | E | D | <2> |

As shown in Table 1, respective Examples exhibited excellent result as a product to be used in all evaluations. On the other hand, in Comparative Examples 1 and 2, rainbow unevenness causing a problem as a product was observed. Additionally, in Comparative Example 3, it was not possible to obtain the multi-layer film before evaluation.

A layer functioning as an antireflection layer was formed on the multi-layer film of Examples exhibiting excellent result to form an antireflection film. Then, the adhesion and rainbow unevenness were evaluated in the same method as those in Evaluation 1 and 4. Both antireflection films were excellent in adhesion on the interface thereof and prevented occurrence of rainbow unevenness. As a result, it was confirmed that both antireflection films had very excellent optical properties such as antireflection performance. Note that the antireflection layer described above was obtained by applying UV curing polymer (product name: TU2111, refractive index of 1.39, and produced by JSR Corporation) to the multi-layer film obtained in each Example, and drying and hardening the same. The thickness of the antireflection layer was 90 nm. Further, the antireflection film thus obtained was set on an area from which commercially available PDP optical filter was removed. Then, it was confirmed that the antireflection film prevented the occurrence of rainbow unevenness and had very excellent optical properties such as antireflection performance.

The present invention is not to be limited to the above embodiments, and on the contrary, various modifications will be possible without departing from the scope and spirit of the present invention as specified in claims appended hereto.

1. A multi-layer film comprising:
a base material formed of polyester;
a first layer disposed on at least one of surfaces of said base material and containing a binder having a refractive index of 1.60 or more and fine particles having any one of tin oxide, indium oxide, zirconium oxide, and titanium oxide as a main component, a refractive index η2 of said first layer being larger than a refractive index η1 of said base material; and
a second layer disposed on said first layer, a refractive index η3 of said second layer being larger than said η2.

2. A multi-layer film as defined in claim 1, wherein said η1, said η2, and said η3 satisfy a formula denoted by 0.03≦η2−(η1×η3)^{1/2}≦0.03.

3. A multi-layer film as defined in claim 2, wherein said binder includes polyester.

4. A multi-layer film as defined in claim 3, wherein said first layer further contains a compound having a plurality of carbodiimide structures in its molecule.

5. A multi-layer film as defined in claim 4, wherein a wavelength λ of visible light of not less than 500 nm and not more than 600 nm, a thickness d1 (nm) of said first layer, and said η2 satisfy a formula denoted by 30≦d1−{λ/(4×η2)}≦30.

6. A multi-layer film as defined in claim 5, wherein said polyester for said base material is polyethylene terephthalate, and both η2 and η3 are 2.0 or less.

7. A multi-layer film as defined in claim 6, wherein said second layer is a hard coat layer.

8. A multi-layer film as defined in claim 7, wherein an antireflection layer is disposed on said hard coat layer.

9. A multi-layer film as defined in claim 8, wherein a refractive index of said antireflection layer is 1.50 or less.

10. An image display device comprising a multi-layer film as defined in claim 1.
